(19) United States
(12) Patent Application Publication
(10) Pub. No.: US 2009/0029116 A1
(43) Pub. Date: Jan. 29, 2009

(54) CUSTOMIZABLE CONTAINER IDENTIFICATION DEVICE

(76) Inventor: David Harruff, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/829,717

(22) Filed: Jul. 27, 2007

(51) Int. Cl. B32B 3/00; B32B 38/14

(52) U.S. Cl. 428/189; 156/277

(57) ABSTRACT

A container identification device for marking a container is provided. The container identification device includes a primary layer securable to the container and a secondary layer releasably secured to a top surface of the primary layer. The secondary layer is adapted to transfer a customizable marking onto the top surface of the primary layer when an impression is made on the secondary layer.

### BACKGROUND

Bottled water often goes to waste because a person sets the bottle down after partial consumption, and thereafter forgets which bottle is his or hers. This is also true for soda bottles, canned beverages, or other types of containers. With increased awareness of global warming and the push to “go green”, it is desirous to reuse and recycle materials as much as possible. To alleviate confusion and prevent waste, a marking can be made on the bottle to differentiate the container from other similar containers. A writing utensil such as a marker or pen can be used to mark the bottle; however, a pen or marker is often unavailable. Similarly, a tag, sticker, sleeve, etc. may also be used to identify the owner of the bottle; however, the tag, sticker, or sleeve must often be marked with a pen, marker, etc. to provide identification.

Thus, it is desired to have a container identification device that is secured to the container when it reaches the consumer or is easily attachable thereto, wherein the container identification device can be used to uniquely identify the container without the use of a writing utensil.

### SUMMARY

A container identification device for marking a container is provided. The container identification device includes a primary layer securable to the container and a secondary layer releasably secured to a top surface of the primary layer. The secondary layer is adapted to transfer a customizable marking onto the top surface of the primary layer when an impression is made on the secondary layer.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated by reference to the following detailed description, when taken in conjunction with the accompanying drawings, wherein:

FIG. 1 is an environmental view of one suitable embodiment of a container identification device constructed in accordance with aspects of the present disclosure, wherein the container identification device is shown secured to a container;

FIG. 2 is an exploded view of the container identification device of FIG. 1;

FIG. 3 is a partial cross-sectional view of the container identification device of FIG. 2, wherein the container identification device is shown assembled;

FIG. 4 is an isometric view of the container identification device of FIG. 1, wherein a portion of the container identification device is partially removed;

FIG. 5 is an isometric view of the container identification device of FIG. 1, wherein a user is inscribing a marking on the container identification device with a fingernail; and

FIG. 6 is an isometric view of the container identification device of FIG. 1, wherein a portion of the container identification device is partially removed to reveal a marking on the container identification device.

### DETAILED DESCRIPTION

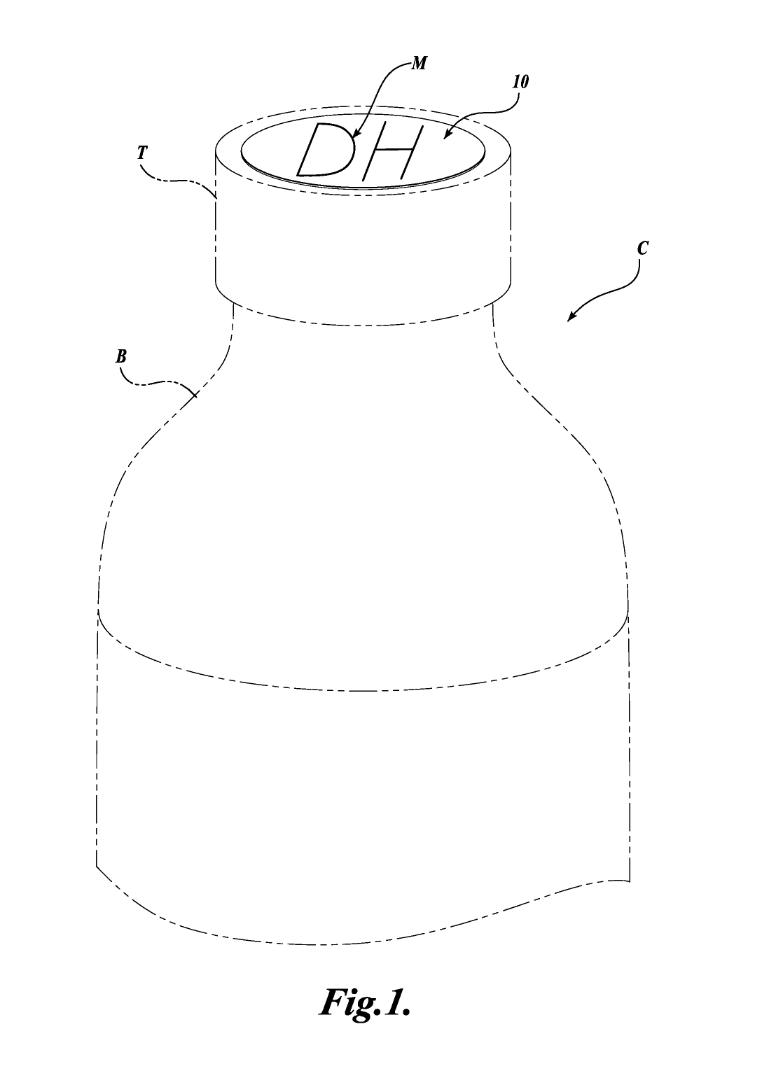

A container identification device 10 will now be described with reference to FIGS. 1-5 where like numerals correspond to like elements. Referring to FIG. 1, the container identification device 10 is shown in use with a container C having a body B and a cap or top T, such as a disposable bottle of water. It should be appreciated that the container identification device 10 may be used on any suitable container or other storage device to uniquely identify the owner of the container, the contents therewithin, etc. Accordingly, the following descriptions and illustrations herein should be considered illustrative in nature, and thus, not limiting the scope of the present disclosure.

FIG. 1 illustrates one exemplary embodiment of a container identification device 10 secured to a container C for identifying the container C. The container identification device 10 is shown secured to the top T of the container C; however, the container identification device 10 may instead be secured to other portions of the container C, such as the body B. The container identification device 10 is used to form a unique, customized marking M on the container C to differentiate the container C from other like containers.

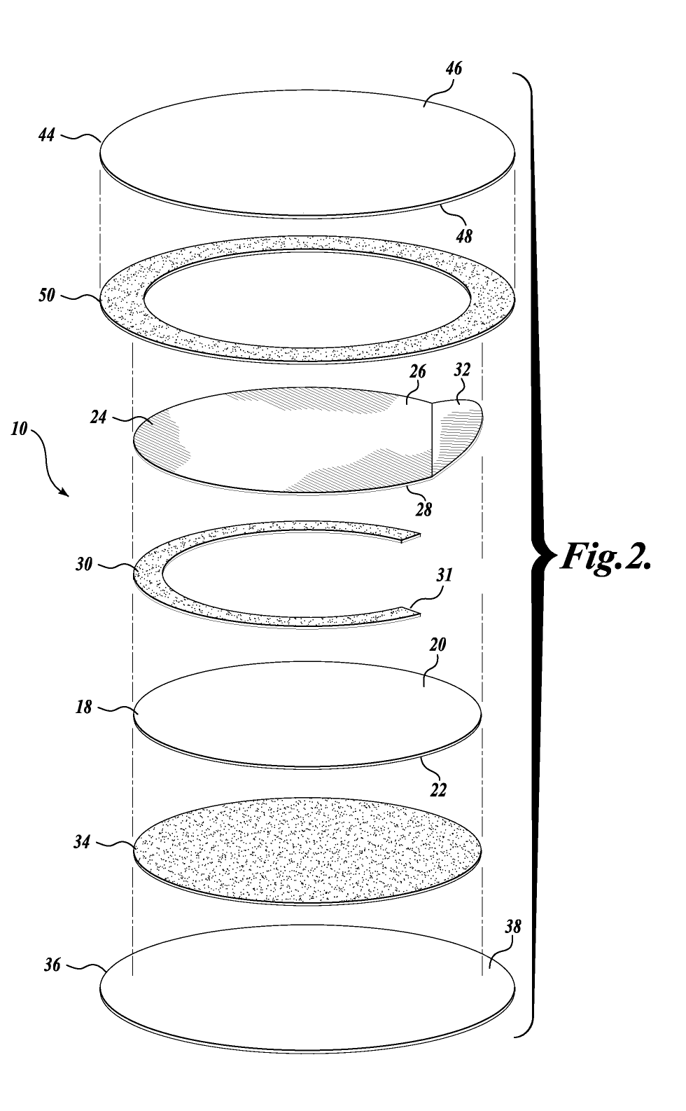

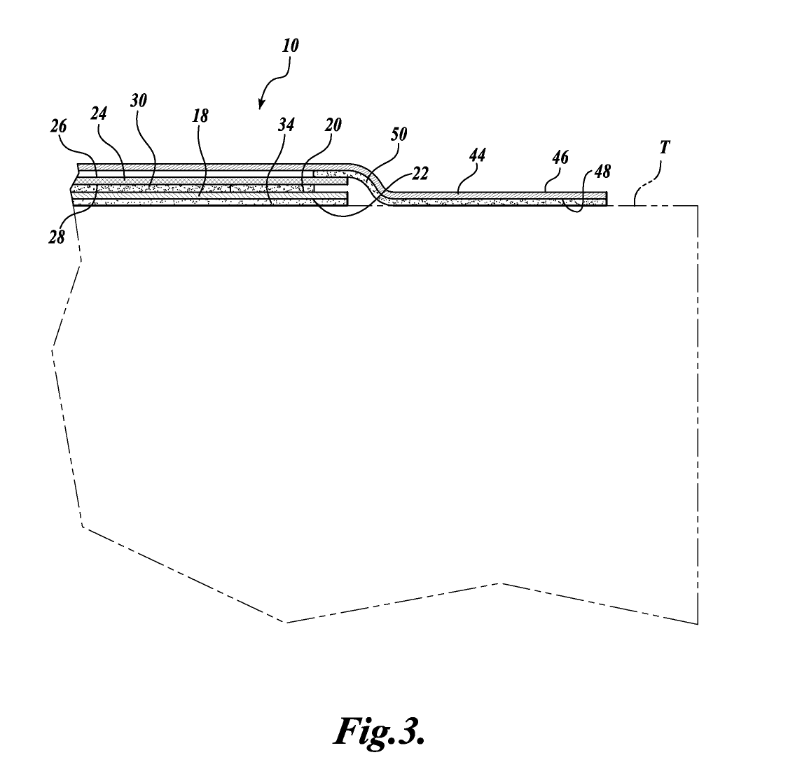

Referring to FIGS. 2 and 3, the container identification device 10 is comprised of a plurality of layers secured together to cooperatively define the container identification device 10. Preferably, each layer is substantially circular and sized to fit on the top T of the container C; however, other shapes and sizes may also be appreciated.

The container identification device 10 includes a primary layer 18 having a top surface 20 and a bottom surface 22, and a secondary layer 24 having a top surface 26 and a bottom surface 28. The primary layer 18 is positioned beneath and engages the secondary layer 24. The primary layer 18 and secondary layer 24 cooperatively form a two-sheet carbonless transfer system. The carbonless transfer system uses a carbonless paper technology to create a marking on the primary layer top surface 20. For instance, the bottom surface 28 of the secondary layer 24 may be coated with a micro-encapsulate dye or ink, and the top surface 20 of the primary layer 18 may be coated with a reactive clay, as are well known in the art. When an impression is made on the top surface 26 of the secondary layer 24 with a rigid instrument, the pressure from the rigid instrument causes the clay to react with the dye to form a permanent mark on the top surface 20 of the primary layer 18.

In the alternative, the primary layer 18 may simply be a sheet of plain paper, and the bottom surface 28 of the secondary layer 24 may be coated with both dye and reactive clay. As yet another alternative, the primary layer top surface 20 may include both the dye and reactive clay, and the secondary layer 24 may be a sheet of plain paper. Using either alternative, an impression is made on the top surface 26 of the secondary layer 24, and the pressure from the rigid instrument causes the clay to react with the dye. With the top surface 20 of the of the primary layer 18 engaging the bottom surface 28 of the secondary layer 24, a permanent mark is formed on the top surface 20 of the primary layer 18. It should be appreciated that any other suitable transfer technology may be used without departing from the sprit and scope of the present disclosure.

The secondary layer 24 is temporarily securable to the primary layer 18 through a first intermediate adhesive layer 30 applied to the bottom surface 28 of the secondary layer 24. The adhesive may be any suitable low-tack, pressure-sensitive, temporary adhesive, such as an adhesive containing rubber, acrylic, etc. The first intermediate adhesive layer 30 may be applied to the bottom surface 28 of the secondary layer 24 in any suitable manner, such as by calendaring, coating, etc.

The first intermediate adhesive layer 30 does not cover the entire bottom surface 28 of the secondary layer 24 such that the adhesive layer 30 does not preclude the carbonless transfer between the secondary layer 24 and the primary layer 18. As shown in FIG. 2, the first intermediate adhesive layer 30 is applied only around the perimeter of the secondary layer bottom surface 28, leaving an opening in the middle such that the bottom surface 28 of the secondary layer 24 is engageable with the top surface of the primary layer 18. Moreover, a gap 31 may be formed in the first intermediate adhesive layer 30 along a portion of the perimeter of the secondary layer 24 such that an edge portion of the secondary layer 24 is not adhesively secured to the primary layer 18. In the current embodiment, the secondary layer 24 includes a tab portion 32 disposed generally over the gap 31 such that a user may easily pull the tab 32 to peel the secondary layer 24 from the primary layer 18.

Referring to FIG. 2, the primary layer 18 includes an adhesive base layer 34 applied to its bottom surface 22 for securing the container identification device 10 to a container C when ready for use (see FIG. 3). The adhesive base layer 34 is preferably a permanent, pressure sensitive, low tack conventional adhesive that permanently secures two materials together, such as epoxy, polyurethane, neoprene, nitrile, and silicone. The adhesive base layer 34 is preferably formed on the entire bottom surface 22 of the primary layer 18, however, the adhesive base layer 34 may instead be formed on only a portion thereof. The adhesive base layer 34 may have an adequate shear strength and moisture resistance such that the primary layer 18 permanently adheres to the container C, even if the container C is wet (for example, if it is being stored within a cooler having ice). In the alternative, the adhesive base layer 34 may consist only of a satisfactory amount of adhesive such that the adhesive provides adequate shear strength to prevent the primary layer 18 from easily separating from the container C. The adhesive base layer 34 may be applied to the bottom surface 22 of the primary layer 18 in any suitable manner, such as by calendaring, coating, etc.

A protective peelable backing 36 having a top surface 38 may be temporarily secured to the adhesive base layer 34 to protect the adhesive base layer 34 from dirt or moisture prior to application. The peelable backing 36 includes a release coating, such as silicon or wax, on its top surface 38 that permits the primary layer 18 having the permanent adhesive base layer 34 thereon to be removable from the top surface 38 of the backing 36.

The peelable backing 36 is preferably slightly larger than the remaining layers of the container identification device 10 such that the peelable backing 36 may be easily peeled away from the remaining layers when the container identification device 10 is ready to be used. The peelable backing 36 may be sized such that the container identification device 10 can be individually distributed to consumers separately from the container C. In the alternative, the peelable backing 36 may instead be a sheet or strip that temporarily holds a plurality of container identification devices 10 thereon. In this manner, a large number of container identification devices 10 can be sent, for instance, to the container manufacturer such that the container identification devices 10 can be secured to the container C prior to its shipment to the consumer or retailer.

The container identification device 10 optionally includes a removable protective top layer 44 having a top surface 46 and a bottom surface 48. The protective top layer 44 is preferably formed with a water-proof or water-resistant material, such as plastic. The protective top layer 44 is adapted to engage the secondary layer 24, but it is also sufficiently large such that an edge portion of the protective top layer 44 additionally engages the peelable backing 36 (see FIG. 2) or the top T of the container C (see FIG. 3). With the identification device 10 secured to the top T, the primary and secondary layers 18 and 24 and the adhesive layers 30 and 34 are sealed beneath the protective layer 44 and are protected from water damage or other damage.

The protective top layer 44 is releasably secured to the secondary layer 24 and peelable backing 36 (or top T) through a second intermediate adhesive layer 50 secured to the bottom surface 48 of the protective top layer 44. The adhesive may be any suitable low-tack, pressure-sensitive, temporary adhesive, and may be applied to the bottom surface 48 of the protective top layer 44 in any suitable manner.

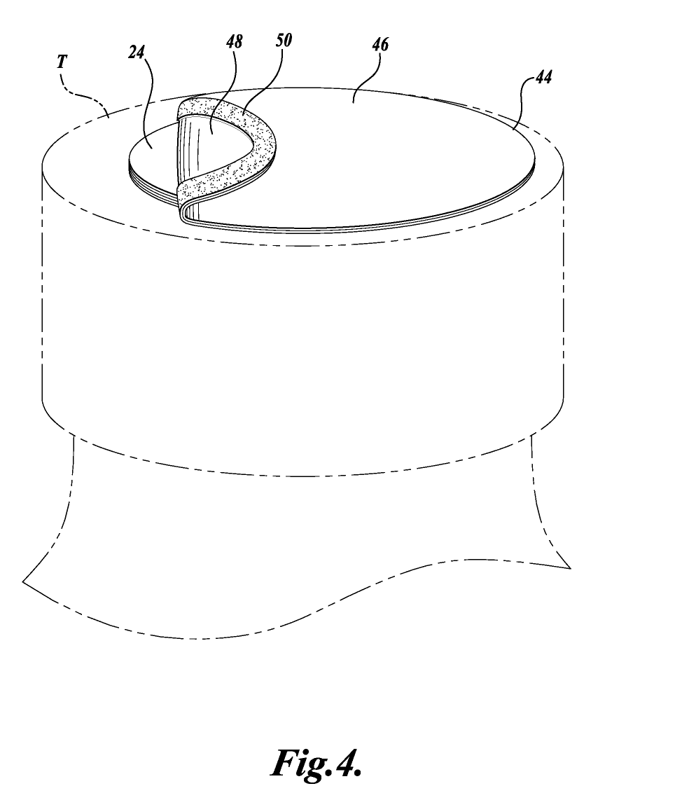

The second intermediate adhesive layer 50 is preferably applied around the perimeter of the protective top layer bottom surface 48, leaving an opening in the middle such that the bottom surface 48 of the protective top layer 44 is engageable with the top surface of the secondary layer 24. As such, an impression can be made on the top surface 46 of the protective top layer 44 with a rigid instrument, thereby making an impression on the top surface 26 of the secondary layer 24 to form a permanent mark on the top surface 20 of the primary layer 18. In the alternative, if the primary layer top surface 20 includes both the dye and reactive clay (as discussed above) the secondary layer 24 may be eliminated and the protective layer 44 may instead adhere directly to the primary layer 18. The protective top layer 44 and the secondary layer 24 are preferably peelable from the remaining layers at the same time. In the alternative, the protective top layer 44 can be first peeled away from the secondary layer 24, as shown in FIG. 4, such that an impression may be made directly on the top surface 26 of the secondary layer 24.

In use, the container identification device 10 is first secured to the container C either by the consumer or at the container manufacturer prior to its shipment to the retailer or consumer. To secure the container identification device 10 to the container C, the peelable backing 36 is peeled away from the primary layer 18 to reveal the adhesive base layer 34 on the bottom surface 22 of the primary layer 18. The container identification device 10 is then secured to the container C in any suitable location, such as on the top T, through the adhesive base layer 34 (see FIG. 3).

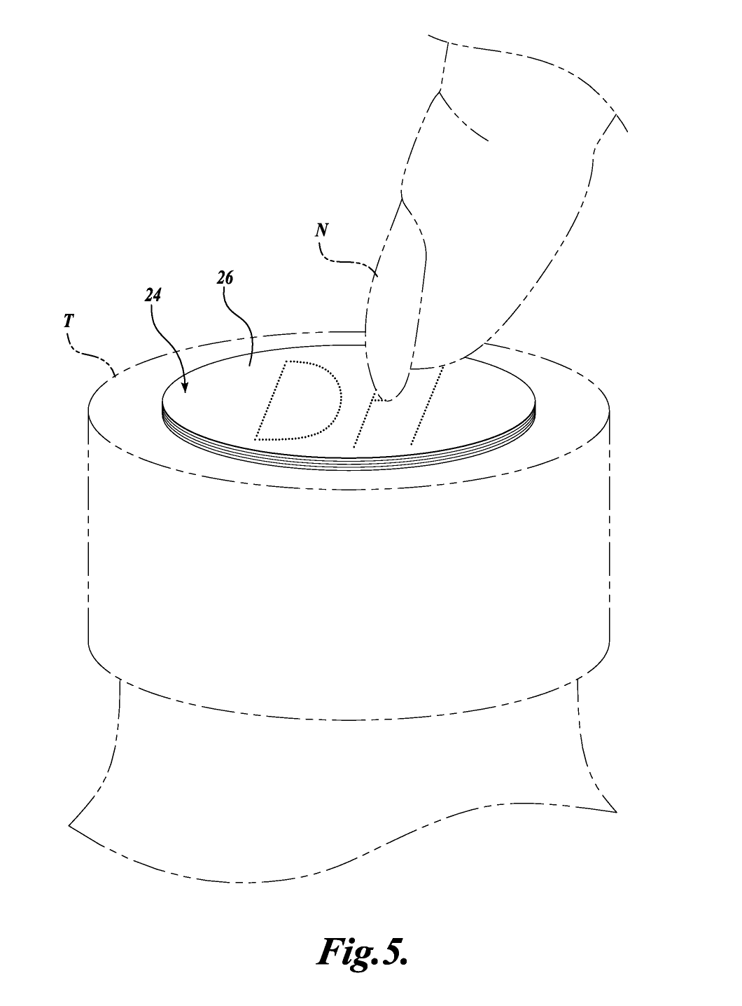

After securing the container identification device 10 to the container C, the top protective layer 44 is peeled away from the remaining layers to reveal the secondary layer 24, as shown in FIG. 4. Referring to FIG. 5, the secondary layer 24 is exposed so that the consumer can make an impression thereon with a rigid device, such as with his or her fingernail N. An appropriate impression is made on the secondary layer 24 to distinguish and/or identify the owner, contents, etc. of the container C.

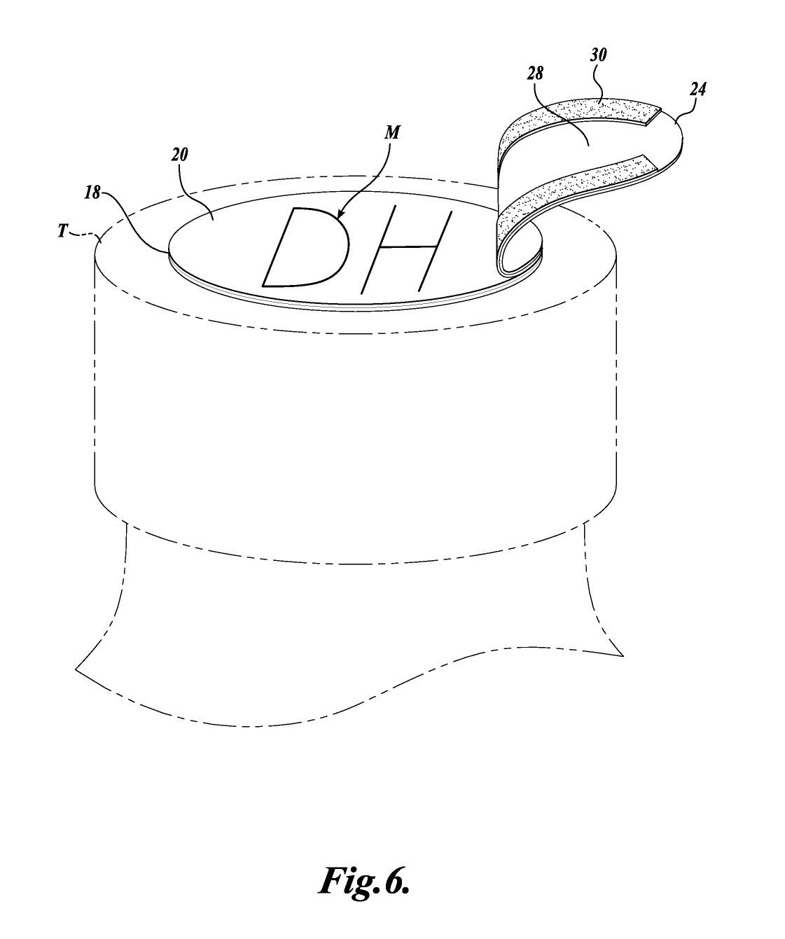

Referring now to FIG. 6, the secondary layer 24 is removed after making an impression thereon to reveal a marking M on the top surface 20 of the primary layer 18. Thus, a unique marking M is applied to the container C without the use of a writing utensil. Therefore, the container C can be distinguished from other similar-looking containers in practically any situation.

While illustrative embodiments have been illustrated and described, it will be appreciated that various changes can be made therein without departing from the spirit and scope of the present disclosure.

The embodiments of the present disclosure in which an exclusive property or privilege is claimed are defined as follows:

1. A container identification device, comprising:
(a) a primary layer securable to a container; and
(b) a secondary layer releasably secured to a top surface of the primary layer, wherein the secondary layer is adapted to transfer a customizable marking onto the top surface of the primary layer when an impression is made on the secondary layer.

2. The container identification device of claim 1, wherein the primary layer and the secondary layer cooperatively form a carbonless transfer system.

3. The container identification device of claim 2, wherein the secondary layer is a carbonless paper layer and the top surface of the primary layer is adapted to receive carbonless transfers thereon.

4. The container identification device of claim 1, wherein the secondary layer includes a top surface and a bottom surface, and wherein the bottom surface of the secondary layer is releasably secured to the top surface of the primary layer.

5. The container identification device of claim 4, further comprising a protective layer releasably secured to the top surface of the secondary layer, wherein the protective layer is larger than the secondary layer and the primary layer such that when the protective layer is releasably secured to the secondary layer, a portion of the protective layer is releasably securable to the container to seal the primary layer and the secondary layer therebeneath.

6. The container identification device of claim 1, wherein the primary layer is securable to a cap of a container.

7. A container identification device, comprising:
(a) a primary layer securable to a container;
(b) a secondary layer releasably securable to the primary layer; and
(c) means for marking the primary layer in response to a corresponding force applied to the secondary layer.

8. The container identification device of claim 7, wherein the secondary layer is a carbonless paper layer adapted to transfer a customizable marking onto the primary layer when an impression is made on the secondary layer.

9. The container identification device of claim 7, further comprising a protective layer releasably securable to the secondary layer and the container to seal the primary layer and the secondary layer therebeneath.

10. The container identification device of claim 1, wherein the primary layer is securable to a cap of a container.

11. A method for identifying a container, comprising:
(a) securing an identification device to a container, the identification device comprising:
(i) a primary layer; and
(ii) a secondary layer releasably secured to the primary layer;
(b) marking the secondary layer with a marking device; and
(c) removing the secondary layer to reveal a customized marking on the primary layer.

12. The method of claim 11, wherein the secondary layer is a carbonless paper layer adapted to transfer a customizable marking onto the primary layer when a marking is made on the secondary layer.

13. The method of claim 11, further comprising marking the secondary layer with a fingernail.

14. The method of claim 11, wherein the identification device further comprises a protective layer releasably secured to the secondary layer and the container.

15. The method of claim 14, further comprising removing the protective layer together with the secondary layer to reveal a customized marking on the primary layer.
